(19) United States
(12) Patent Application Publication
(10) Pub. No.: US 2003/0081649 A1
(43) Pub. Date: May 1, 2003

(54) Fuel temperature sensing using an inductive fuel level sensor

(76) Inventors: Lance Ronald Strayer, Clarkston, MI (US); Michael D. Lutton, Grand Blanc, MI (US); Chris C. Begley, Ortonville, MI (US)

Correspondence Address: VINCENT A. CICHOSZ, DELPHI TECHNOLOGIES, INC., Legal Staff, Mail Code:480-414-420, P.O. Box 5052, Troy, MI, 48007-5052, US

(21) Appl. No.: 10/001,571

(22) Filed: Nov. 1, 2001

(51) Int. Cl. G01K 1/14; G01K 7/00

(52) U.S. Cl. 374/142; 374/183; 374/163

(57) ABSTRACT

This invention provides a method and apparatus for utilizing an inductive coil fluid level sensor to measure the temperature of the fuel, or fuel vapors, in a fuel tank depending upon the location of the sensor within the tank. The inductive coil sensor is connected to a Fuel Control Unit containing the sensor electronics to drive the inductive coil sensor and read the corresponding fuel or fuel vapor temperature.

### TECHNICAL FIELD

This disclosure relates to temperature sensors and more particularly to fuel, or fuel vapor, temperature sensing using an inductive fuel level sensor.

### BACKGROUND

Current automotive fuel or fuel vapor temperature sensing is performed with a thermistor positioned within a fuel tank. This requires an additional component (the thermistor) in the fuel system. It also requires two electrical connections, e.g., one for signal output and one for electrical ground.

The ground connection can be shared. However, this still requires a minimum of one extra system electrical connection. The disadvantage to this approach is the cost of the thermistor and the extra electrical connections. Another concern is the ability of the thermistor to withstand being in contact with the fuels and fuel vapors. It is therefore advantageous to provide a fuel or fuel vapor temperature sensing apparatus and method that does not require either extra components nor extra electrical connections and that can provide long term reliability.

### SUMMARY OF THE INVENTION

This disclosure provides a method and apparatus for utilizing an inductive coil fluid level sensor to measure the temperature of the fuel, or fuel vapors, in a fuel tank depending upon the location of the sensor within the tank. The inductive coil sensor is connected to a Fuel Control Unit containing the sensor electronics to drive the inductive coil sensor and read the corresponding fuel or fuel vapor temperature.

The method comprises charging the sensor to generate a voltage across the sensor, measuring the voltage across the sensor at the temperature of the sensor, measuring the voltage across the sensor at a reference temperature; and from the voltage measured across the sensor at the temperature of the sensor and the voltage measured across the sensor at the reference temperature, calculating the temperature of the sensor with respect to the reference temperature.

The sensor comprises an inductive coil receptive of a magnetic core moveable within the coil, a device linked to the core and responsive to the level of the fluid in a container and a circuit charging the inductive coil generating thereby a voltage across the inductive coil indicative of the temperature of the fluid.

### BRIEF DESCRIPTION OF THE DRAWINGS

FIG. 1 is a generalized schematic diagram of an electro-mechanical system having an electric circuit including an inductive coil sensor for determining the temperature of a fuel or fuel vapor in a container;

FIG. 2 is a schematic diagram of a first embodiment of the inductive coil sensor of FIG. 1 immersed within the fuel;

FIG. 3 is a schematic diagram of a second embodiment of the inductive coil sensor of FIG. 1 immersed within the fuel vapor;

FIG. 4 is a schematic diagram of a first exemplary embodiment of the electric circuit of FIG. 1 including a model of an inductive coil sensor for determining the temperature of a fuel or fuel vapor in a container;

FIG. 5 is a schematic diagram of a second exemplary embodiment of the electric circuit of FIG. 1 including a model of an inductive coil sensor for determining the temperature of a fuel or fuel vapor in a container;

FIG. 6 is a schematic diagram of a third exemplary embodiment of the electric circuit of FIG. 1 including a model of an inductive coil sensor for determining the temperature of a fuel or fuel vapor in a container;

FIG. 7 is a schematic diagram of an electric circuit, including a model of an inductive coil sensor, for determining the level of a fuel in a container;

FIG. 8 is a graphical representation of the square wave driving pulse voltage, Vₚᵤₗₛₑ, of FIG. 1 and the resultant voltage, V_{coil}, across the inductive coil sensor;

FIG. 9 is a graphical representation of the exponential decay of V_{coil} wherein the core of the inductive coil sensor is not inserted into the coil; and

FIG. 10 is a graphical representation of the exponential decay of V_{coil} wherein the core of the inductive coil sensor is fully inserted into the coil.

### DETAILED DESCRIPTION OF THE INVENTION

An inductive coil is constructed by winding a given number of turns of conductive wire onto a bobbin. Copper is typically used due to its low cost and low electrical resistance. Although the resistance of the inductive coil, R_{coil}, is small, it is easily measurable. Copper has a very well defined change in resistance due to temperature. The temperature coefficient of resistance, α, for Copper as given by The Engineers' Manual by Hudson is 0.00393 per degree C. at 20 degrees C. By analyzing the change in resistance in the copper coil, R_{coil}, the temperature change of the coil, T_{coil}, can be determined.

Referring now to FIG. 1, a generalized schematic diagram is shown of an electro-mechanical system 100 having an electric circuit 100a including an inductive coil sensor 108 for determining the temperature of a fluid such as a fuel or fuel vapor in a container. The sensor 108 for measuring the temperature of the fluid 104, comprises an inductive coil 108b receptive of a magnetic core 108a moveable within the coil 108b. A flotation device 106a is mechanically linked at 106 to the core 108a and responsive to the level of the fluid 104 in the container 102, such as a fuel tank. A circuit 100a charges the inductive coil 108b generating thereby at 110b a voltage, V_{coil}, across the inductive coil 108b indicative of the temperature of the fluid 104.

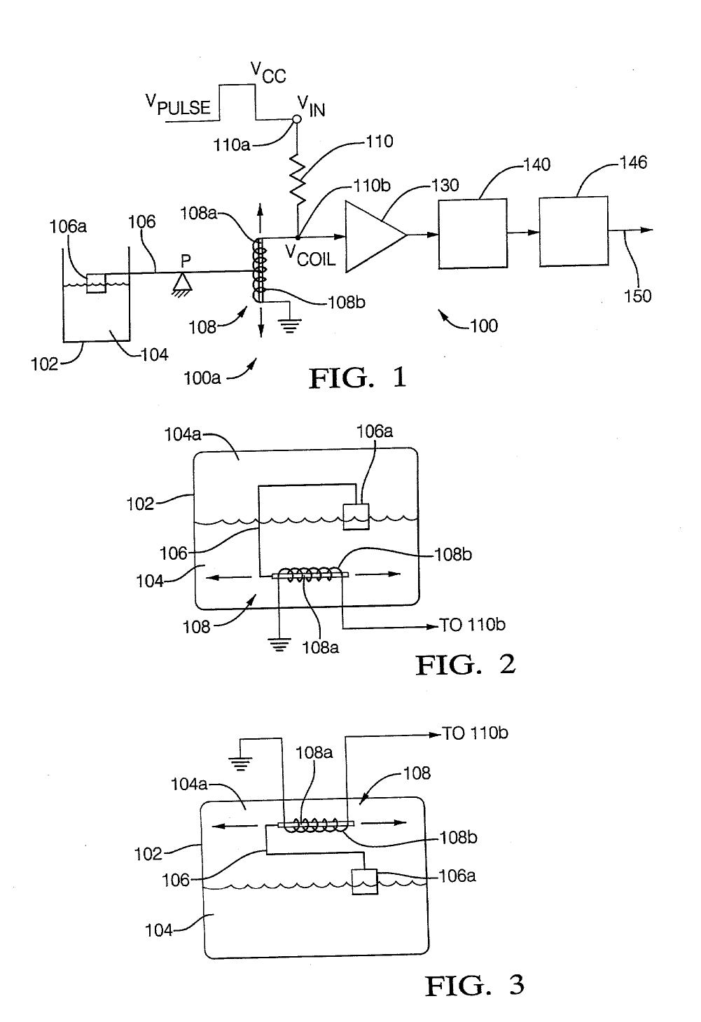

As the flotation device 106a rises and falls with the level of the fuel 104, the core 108a falls and rises as the lever arm 106 pivots about point P. The movement of the core 108a within the coil 108b causes the effective inductance of the coil 108b to change in a measurable way. As seen in FIG. 1, the inductive coil sensor 108 may be located remote from the fuel tank 102 or as seen in FIG. 2 and 3, may be located within the fuel tank 102. To measure the temperature, Tᵥ, of the fuel vapor 104a, the inductive coil sensor 108 is located within the tank 102 above the fuel 104. To measure the temperature, T_{f}, of the fuel 104, the inductive coil sensor 108 is located within the tank 102 immersed within the fuel 104.

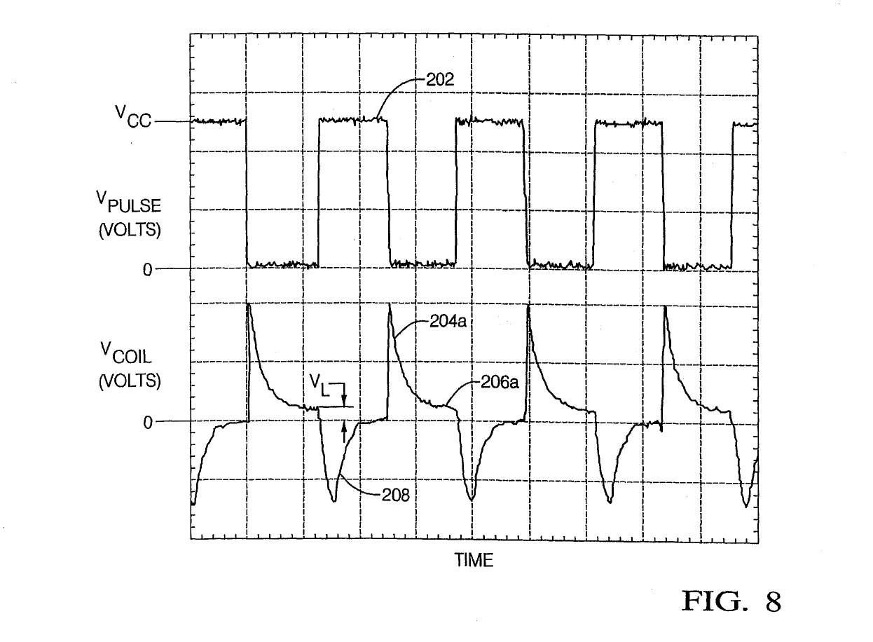

In FIG. 1, an input terminus 110a of input resistor 110 is energized by a square wave signal, Vₚᵤₗₛₑ, having values of 0 volts and V_{cc} volts as seen for example at 202 in FIG. 8. Such a voltage input at 110a results in a corresponding coil voltage, V_{coil}, at an output terminus 110b of the input resistor 110. In FIG. 1, V_{coil} is amplified by an amplifier 130 which provides as output a signal, Vₒᵤₜ, which is filtered at 140. The output of the filter is provided as input to an analog-to-digital converter (ADC) 146.

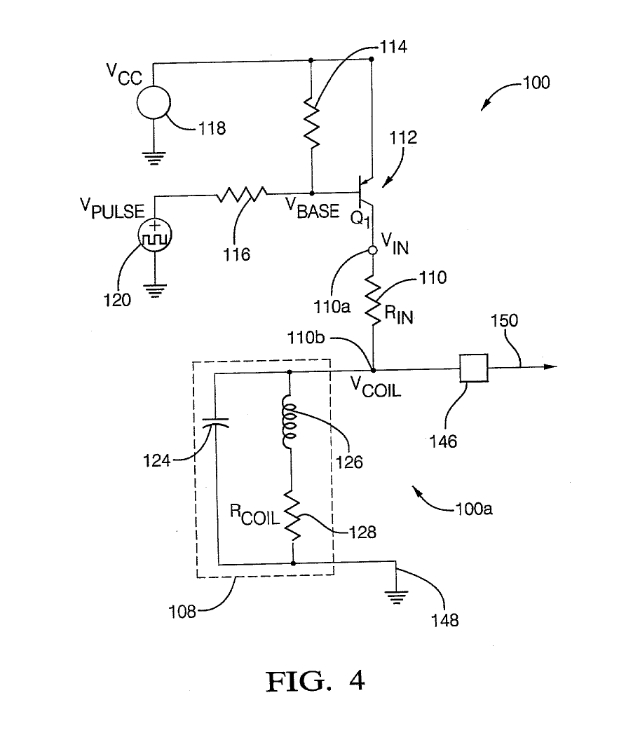

Referring to FIG. 4, a first exemplary embodiment of the circuit 100a of FIG. 1 is shown. In FIG. 4, Vₚᵤₗₛₑ is provided by an oscillator 120 connected to the base of a pnp bipolar junction transistor 112 (Q₁) having a supply voltage, V_{cc}, of 5 volts provided by a power source 118. Q₁ 112 is used to switch V_{cc} to the coil sensor through Rᵢₙ 110. The coil sensor 108 of FIG. 1 can be modeled as a parallel RLC circuit 124, 126, 128. In the circuit shown in FIG. 4, Rᵢₙ is chosen to be much larger than R_{coil} 128. This allows the resistance of the coil, R_{coil}, to be neglected in determining the effective inductance of the coil to determine fuel level. The value of V_{coil} is relatively low if Rᵢₙ is much greater than R_{coil} as required to measure the effective inductance of the coil 108a.

A method of measuring R_{coil} is to measure the voltage, V_{coil}, across the coil 108. In order to measure V_{coil}, the square wave 202 used to measure the effective inductance is halted temporarily at zero volts and transistor Q₁ in FIG. 4 would remain turned “on” (for about 100 msec) until the coil 108 is fully charged. Once the coil 108 is fully charged, the voltage across the coil is given by

$${V}_{c o i l} = \frac{{R}_{c o i l}}{{R}_{c o i l} + {R}_{i n}} \times {V}_{i n} . \qquad ( 1 )$$

If Rᵢₙ and Vᵢₙ do not vary with temperature, then R_{coil} would be the only temperature dependent variable. To accomplish this, Rᵢₙ is chosen to be a discrete resistor with a low temperature coefficient as is common with carbon resistors. The voltage difference between V_{cc} and Vᵢₙ is negligible for low currents flowing through Q₁. V_{cc} can vary somewhat with temperature but this can be neglected if the analog-to-digital converter (ADC) 146 is also powered by V_{cc}. Therefore, the coil voltage, V_{coil}, can be approximated to vary in the same fashion as the temperature coefficient of resistance of copper (0.393% per degree C).

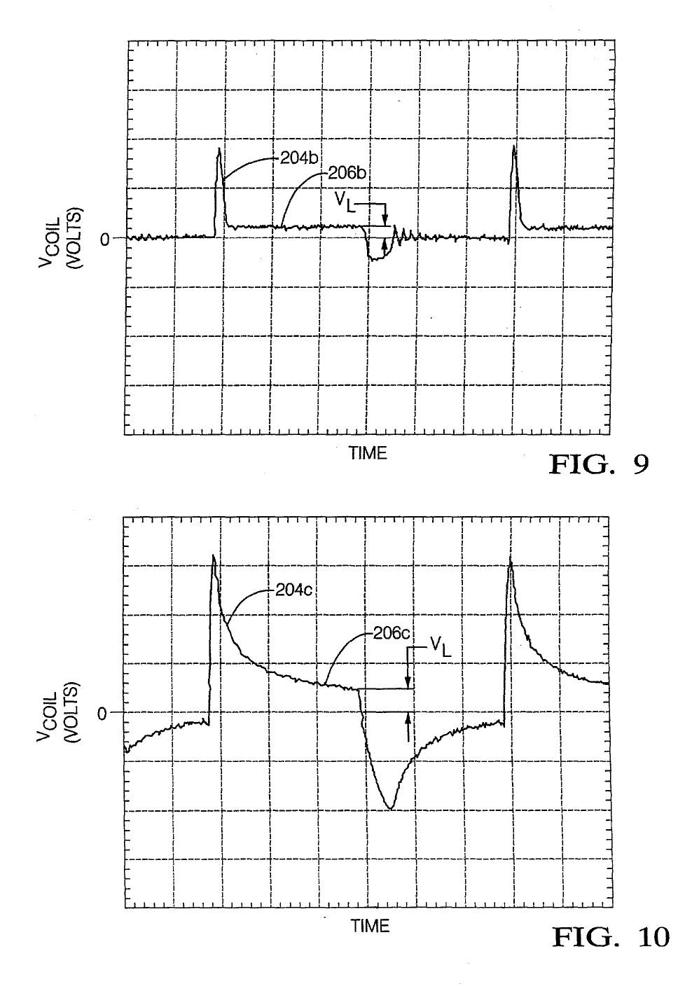

As seen in FIGS. 1 and 8, Vᵢₙ is alternately energized and de-energized at 110a by a square wave pulse, Vₚᵤₗₛₑ, 202 having values of zero volts and V_{cc} volts. When Vₚᵤₗₛₑ is positive (Q₁ off), V_{coil} grows exponentially as seen at 208 in FIG. 8. When Vₚᵤₗₛₑ is zero (Q₁ on), the inductor 126 is charging and V_{coil} decays exponentially as seen at 204a. Depending upon the time constant, τ_{L}, of the coil sensor 108, as seen at 206a, V_{coil} will decay to a substantially constant value V_{L} after a prescribed time interval, tₒ. It will be appreciated from FIGS. 9 and 10 that as the core 108a moves into and out of the coil 108b, the time constant, τ_{L}, of the coil sensor 108 changes and the rate of the exponential decay will change. Thus, FIG. 9 is representative of the sensor 108 charging when the core 108a is substantially out of the coil 108b and FIG. 10 is representative of the sensor 108 charging when the core 108a is more fully encompassed by the coil 108b. Q₁ is left turned on for a sufficiently long time interval, t₁>tₒ (e.g., 100 msec) until V_{coil} settles to the substantially DC voltage level of V_{L}. At such time, in the circuit model 108 of FIG. 4, inductor 126 acts as a short circuit and capacitor 124 acts an open circuit. Thus, at t₁ a voltage divider is created between Vᵢₙ at 110a, V_{coil} at 110b and electrical ground at 148. Thus, since Vᵢₙ approximates V_{cc},

$${V}_{L} ( {T}_{c o i l} ) = \frac{{R}_{c o i l} ( {T}_{c o i l} )}{{R}_{c o i l} ( {T}_{c o i l} ) + {R}_{i n}} \times {V}_{c c} . \qquad ( 2 )$$

In the circuit of FIG. 1, V_{L} is about 120 mV if R_{coil} is about 25 Ohms and Rᵢₙ is 1000 Ohms. If V_{L} has been measured at a reference temperature T₀, then

$${V}_{L} ( {T}_{0} ) = \frac{{R}_{c o i l} ( {T}_{0} )}{{R}_{c o i l} ( {T}_{0} ) + {R}_{i n}} \times {V}_{c c} . \qquad ( 3 )$$

R_{coil} varies with temperature T_{coil} according to the equation:

R_{coil}(T_{coil})=R_{coil}(T₀)[1+α(T_{coil}−T₀)], (4)

where α is the temperature coefficient of resistance. Equations (2) and (3) can be substituted into Eq. (4) to give the difference between T_{coil} and T₀:

$${T}_{c o i l} - {T}_{0} = \frac{1}{α} [ ( \frac{{V}_{L} ( {T}_{c o i l} )}{{V}_{L} ( {T}_{0} )} ) ( \frac{{V}_{c c} - {V}_{L} ( {T}_{0} )}{{V}_{c c} - {V}_{L} ( {T}_{c o i l} )} ) - 1 ] . \qquad ( 5 )$$

As best understood from Eq. 5, Vᵢₙ may be used therein for V_{cc}.

Depending upon the location of the inductive coil sensor 108 within the tank 102 (FIGS. 2 and 3), due to the intimate contact between the fuel 104 or fuel vapor 104a and the coil 108b, the temperature of the coil is equal to the temperature of the fuel 104 or fuel vapor 104a respectively, i.e., T_{coil}=T_{f} or T_{coil}=Tᵥ.

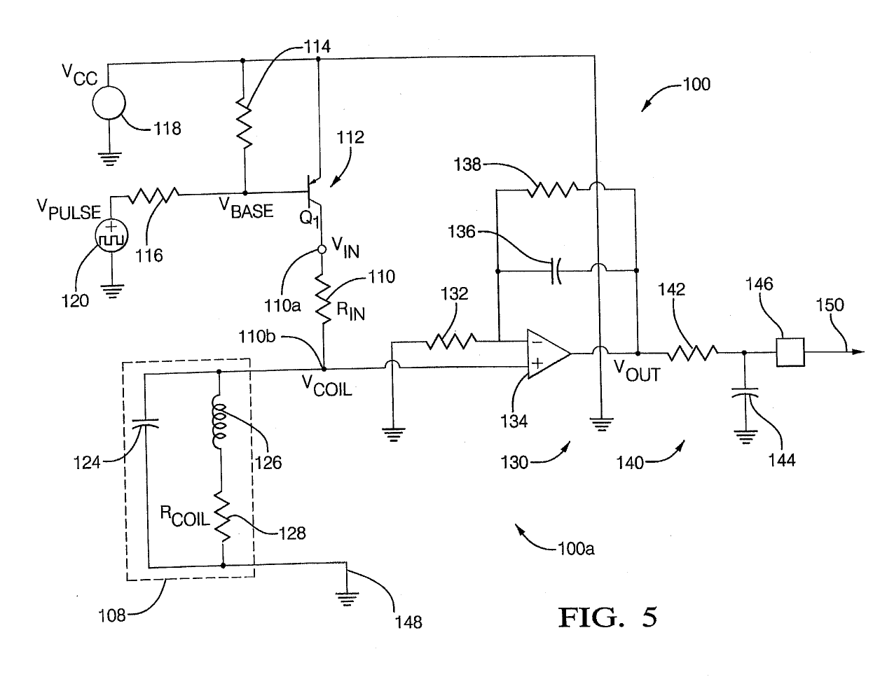

To read a low voltage accurately, a higher resolution ADC 146 is required. A method to reduce the accuracy requirements of the ADC 146 is to amplify the V_{coil} signal as shown at 130 in FIG. 5. In FIG. 5, in a second exemplary embodiment of the circuit 100a, the amplifier 130 of FIG. 1 comprises an operational amplifier 134 having resistors 132 and 138 and capacitor 136 in a negative feedback circuit. The operational amplifier 134 accepts as input thereto V_{coil}, at a positive terminal, and provides as output Vₒᵤₜ. Vₒᵤₜ is an amplified V_{L} (Gain=R₁₃₈/R₁₃₂=33.2, Vₒᵤₜ is about four volts, given that R_{coil} is about 25 Ohms) which is filtered by an RC lowpass filter 142, 144 and provided as input to a microcontroller ADC 146 to determine coil temperature T_{coil}.

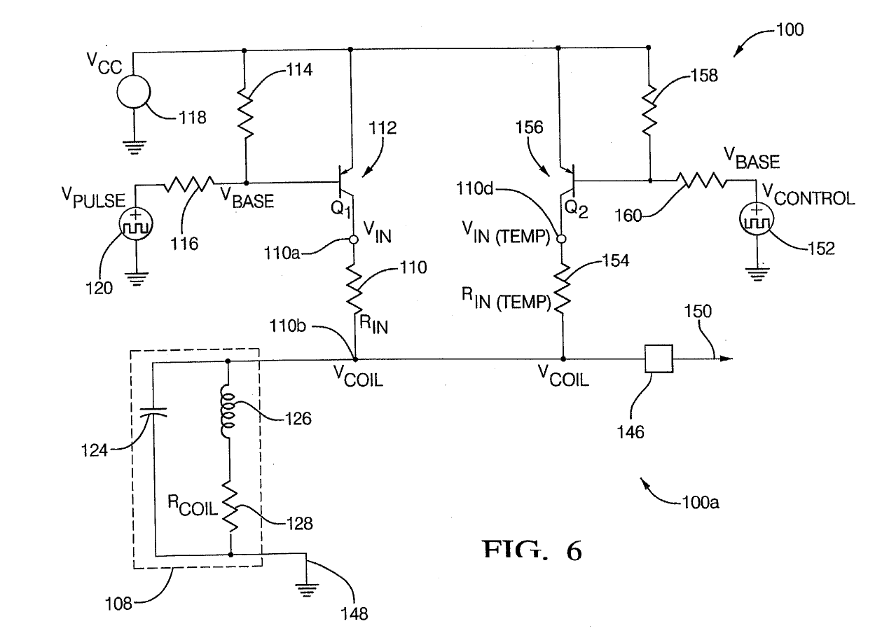

A second method to increase V_{coil} is to use a smaller Rᵢₙ, such as Rᵢₙ₍ₜₑₘₚ₎<Rᵢₙ, as seen in FIG. 6. In FIG. 6, in a third exemplary embodiment of the circuit 100a, the square wave 202 used to drive Q₁ is halted temporarily while Q₂ is turned “on” until the coil 108 is fully charged. The voltage across the coil is then given by

$${V}_{c o i l} = \frac{{R}_{c o i l}}{{R}_{c o i l} + {R}_{i n ( t e m p )}} \times {V}_{i n ( t e m p )} . \qquad ( 6 )$$

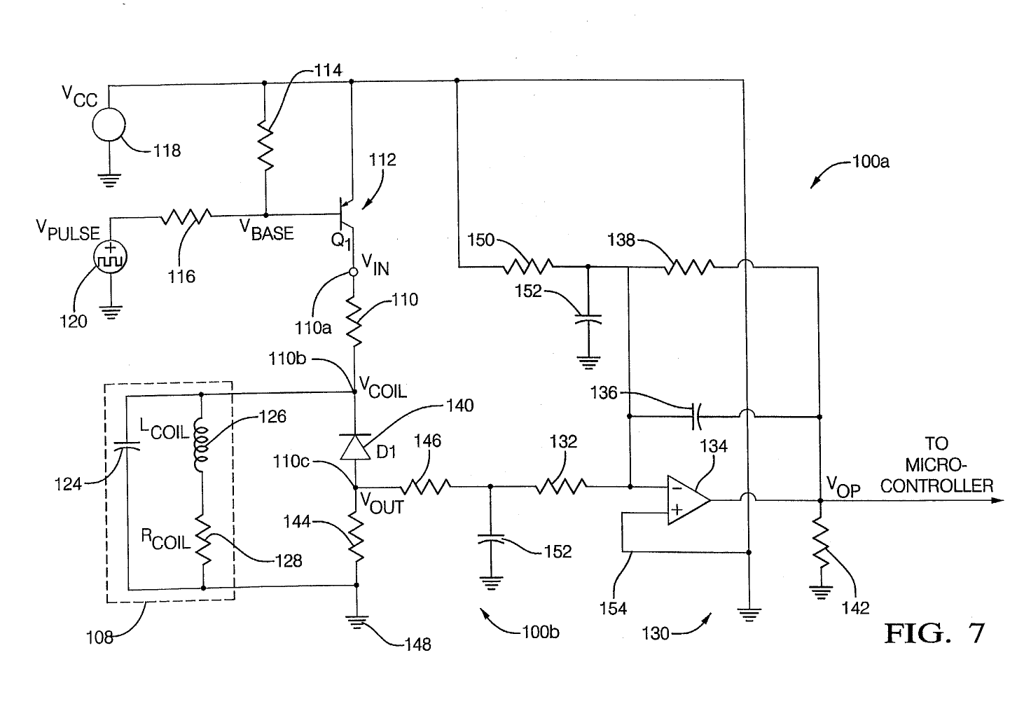

Referring to FIG. 7, a schematic diagram of an electric circuit, including a model of an inductive coil sensor 108, for determining the level of a fuel in a container, is shown generally at 100b. Diode D₁, connected between nodes 110b and 110c, causes the circuit 100a to analyze the negative portion 208 of the V_{coil} waveform. The negative voltage 208 is used rather than the positive voltage 204, 206 because a wiring harness short to either electrical ground or battery voltage will produce a zero output at the Opamp 134. Resistor 144 provides the discharge resistance with current flowing through the diode 140 and determines the time constant for exponential decay in combination with the inductive coil (L_{coil}/R₁₄₄). Resistors 146, 132 and capacitor 148 filter the input signal Vₒᵤₜ, to the operational amplifier 134. The Opamp 134 acts as an integrator to provide an analog voltage output, Vₒₚ, that corresponds to fuel level, which is read by a microcontroller (not shown).

While preferred embodiments have been shown and described, various modifications and substitutions may be made thereto without departing from the spirit and scope of the invention. Accordingly, it is to be understood that the present invention has been described by way of illustration only, and such illustrations and embodiments as have been disclosed herein are not to be construed as limiting the claims.

What is claimed is:

1. A method of measuring the temperature of a fluid utilizing an inductive coil sensor positioned within the fluid, the method comprising:
charging the sensor to generate a voltage across the sensor;
measuring the voltage across the sensor at the temperature of the sensor;
measuring the voltage across the sensor at a reference temperature;
based upon the voltage measured across the sensor at the temperature of the sensor and the voltage measured across the sensor at the reference temperature, calculating the temperature of the sensor with respect to the reference temperature; and
setting the temperature of the fluid equal to the calculated temperature of the sensor.

2. The method as set forth in claim 1 wherein charging the sensor comprises:
alternately energizing and de-energizing the sensor with a voltage waveform; and
maintaining the voltage waveform at one value of the voltage waveform.

3. The method as set forth in claim 2 wherein measuring the voltage across the sensor at the temperature of the sensor comprises measuring the voltage across the sensor when the voltage across the sensor is at a substantially constant value.

4. The method as set forth in claim 3 wherein measuring the voltage across the sensor at the reference temperature comprises measuring the voltage across the sensor when the voltage across the sensor is at a substantially constant value.

5. The method as set forth in claim 4 wherein calculating the temperature of the sensor with respect to the reference temperature comprises calculating the temperature of the sensor with respect to the reference temperature according to the equation
$${T}_{c o i l} - {T}_{0} = \frac{1}{α} [ ( \frac{{V}_{L} ( {T}_{c o i l} )}{{V}_{L} ( {T}_{0} )} ) ( \frac{{V}_{i n} - {V}_{L} ( {T}_{0} )}{{V}_{i n} - {V}_{L} ( {T}_{c o i l} )} ) - 1 ]$$
where T_{coil} is the temperature of the sensor, T₀ is the reference temperature, α is the coefficient of resistance of the material of the sensor at the reference temperature, V_{L} (T_{coil}) is the voltage measured across the sensor at the temperature of the sensor, V_{L} (T₀) is voltage measured across the sensor at the reference temperature and Vᵢₙ is a constant voltage.

6. A method of measuring the temperature of a fluid, the method comprising:
generating an inductance in an inductive coil by charging the inductive coil generating thereby a voltage across the inductive coil;
positioning the inductive coil within the fluid;
measuring the voltage across the inductive coil at the temperature of the inductive coil;
measuring the voltage across the inductive coil at a reference temperature;
from the voltage measured across the inductive coil at the temperature of the inductive coil and the voltage measured across the inductive coil at the reference temperature, calculating the temperature of the inductive coil with respect to the reference temperature; and
setting the temperature of the fluid equal to the calculated temperature of the sensor.

7. The method as set forth in claim 6 wherein charging the sensor comprises:
alternately energizing and de-energizing the sensor with a voltage waveform; and
maintaining the voltage waveform at one value of the voltage waveform.

8. The method as set forth in claim 7 wherein measuring the voltage across the sensor at the temperature of the sensor comprises measuring the voltage across the sensor when the voltage across the sensor is at a substantially constant value.

9. The method as set forth in claim 8 wherein measuring the voltage across the sensor at the reference temperature comprises measuring the voltage across the sensor when the voltage across the sensor is at a substantially constant value.

10. The method as set forth in claim 9 wherein calculating the temperature of the sensor with respect to the reference temperature comprises calculating the temperature of the sensor with respect to the reference temperature according to the equation
$${T}_{c o i l} - {T}_{0} = \frac{1}{α} [ ( \frac{{V}_{L} ( {T}_{c o i l} )}{{V}_{L} ( {T}_{0} )} ) ( \frac{{V}_{i n} - {V}_{L} ( {T}_{0} )}{{V}_{i n} - {V}_{L} ( {T}_{c o i l} )} ) - 1 ]$$
where T_{coil} is the temperature of the sensor, T₀ is the reference temperature, α is the coefficient of resistance of the material of the sensor at the reference temperature, V_{L} (T_{coil}) is the voltage measured across the sensor at the temperature of the sensor, V_{L} (T₀) is voltage measured across the sensor at the refeence temperature and Vᵢₙ is a constant voltage.

11. A sensor for measuring the temperature of a fluid, the sensor comprising:
an inductive coil receptive of a magnetic core moveable within the coil;
a device linked to the core and responsive to the level of the fluid in a container; and
a circuit charging the inductive coil generating thereby a voltage across the inductive coil indicative of the temperature of the fluid.

12. The sensor as set forth in claim 11 wherein the inductive coil is positioned within the fluid.

13. The sensor as set forth in claim 11 wherein the inductive coil is positioned remote from the fluid.

14. The sensor as set forth in claim 11 wherein the device is a flotation device.

15. The sensor as set forth in claim 11 wherein the circuit comprises:
means for alternately energizing and de-energizing the coil with a voltage waveform;
a signal converter for converting the voltage across the inductive coil from analog to digital form; and
wherein the digital form of the voltage across the inductive coil is indicative of the temperature of the fluid.

16. The sensor as set forth in claim 15 wherein the voltage waveform is a binary voltage waveform.

17. The method as set forth in claim 2 wherein alternately energizing and de-energizing the sensor with a voltage waveform comprises alternately energizing and de-energizing the sensor with a binary voltage waveform.

18. The method as set forth in claim 7 wherein alternately energizing and de-energizing the sensor with a voltage waveform comprises alternately energizing and de-energizing the sensor with a binary voltage waveform.
